(19) United States
(12) Patent Application Publication
(10) Pub. No.: US 2003/0208367 A1
(43) Pub. Date: Nov. 6, 2003

(54) Flow composition model searching

(75) Inventors: Netta Aizenbud-Reshef, Haifa (IL); Sara Porat, Ramat Yishav (IL); Shlomit I. Shachor, Yokneam Eilit (IL); Michael Starkey, Vancouver (CA); Stephen J. Todd, Winchester (GB); Gabi Zodik, Nesher (IL)

Correspondence Address: Gerald R. Woods, IBM Corp, IP Law Dept T81/503, 3039 Cornwallis Road, PO Box 12195, Research Triangle Park, NC, 27709-2195, US

(73) Assignee: International Business Machines Corporation, Armonk, NY (US)

(21) Appl. No.: 10/325,037

(22) Filed: Dec. 20, 2002

(30) Foreign Application Priority Data
May 2, 2002 (GB) 0210031.1

(51) Int. Cl. G06F 17/60

(52) U.S. Cl. 705/1

(57) ABSTRACT

An arrangement and method for flow composition model searching by holding in a repository (120) records (130) of flow composition models containing information representative of predetermined flow composition model characteristics thereof, specifying (200) information representative of desired ones of the predetermined flow composition model characteristics, and retrieving from the repository flow control model records matching the specified information. The FCM characteristics may include Message Flow, Work Flow and Connector characteristics. The specified information may include wild card characters. This provides the advantage that a new specification of flow characteristics, derived from the general model FCM, is used. Hence using it enables the application of search, reuse, compare, etc., on any present and future FCM realization.

### FIELD OF THE INVENTION

This invention relates to flow models, and particularly to the searching of flow models.

### BACKGROUND OF THE INVENTION

Business applications are commonly made up of interrelated programs. These often run in multiple and different environments. The problem is to enable business interactions between these disparate entities. Business process management (BPM) conceptualizes business interactions into flows. It takes a more integrated view of a business process than either the simple transfer of information known as application integration (AI) or its routing and transformation known as enterprise application integration (EAI). It involves the total integration and cooperation between all the different entities participating in business activities (including human participation as well as the various applications) which are all likely to be operating in different environments and runtimes.

Business Process Management (BPM) uses a methodology called ‘Flow-Composition’ for modeling application components in a BPM scenario where the complex business services are broken down recursively into simpler entities with both controls and information flowing between them. Flow Composition provides a model for integrating a whole range of technologies and runtime environments. This has been formalized by IBM Corporation into a meta-model known as the Flow Composition Model (FCM) which provides a process-oriented scripting of elemental entities known as components and a modeling paradigm, neutral in terms of the runtime environment.

Using FCM, the business application is presented as a flow which consists of one or more components and connectors between them. Connectors are defined either as data connectors or control connectors. A flow is a visual program describing the processing logic of the application as a directed graph. Flow developers build a flow by selecting components from a pool of predefined components, placing them on a drawing surface, and drawing connectors that define the flow of data and control through these components. A flow can contain a compound component which is itself a flow. In this way flows can be built modularly, and specific flow functionality can be reused.

Known models which can be perceived as realizations of the FCM meta-model are Message Flow, Work Flow and Connector. Message Flows are used for transformation and routing of messages between applications. Work Flows are used for application structuring and resource coordination. Connectors are used for inter-operability with existing applications.

The common model of work with flows (e.g., Message Flows in MQSeries Integrator™) is a central repository where flows are saved. It is shared by several users who in addition handle individual workspaces that reflect a portion of the existing flows. This mode of work leads to a situation where users are typically not aware of the flows that were developed by other users. This might lead to similarities between flows in the repository. Capabilities of search and reuse in such an environment are essential for improving the development process (reusing flows or using them as examples), maintenance, knowledge sharing and collaboration.

However, known FCM schemes are limited in their usefulness by not being able to be readily searched.

A need therefore exists for flow model searching wherein the abovementioned disadvantage(s) may be alleviated.

### STATEMENT OF INVENTION

In accordance with a first aspect of the present invention there is provided an arrangement for flow model searching as claimed in claim 1.

In accordance with a second aspect of the present invention there is provided a method for flow model searching as claimed in claim 16.

In a preferred form this provides the advantage that a new specification of flow characteristics, derived from the general model FCM, is used. Hence using it enables the application of search, reuse, compare, etc., on any present and future FCM realization.

### BRIEF DESCRIPTION OF THE DRAWINGS

One flow model searching scheme incorporating the present invention will now be described, by way of example only, with reference to the accompanying drawings, in which:

FIG. 1 illustrates an FCM locator used in the present invention;

FIG. 2 shows a diagrammatic representation of a visual display produced by a Message Flow Locator wizard used in the present invention; and

FIG. 3 shows a detailed block-schematic diagram illustrating interaction of graphic user interfaces with various repositories et al. for FCM viewing, editing and searching utilising the present invention.

### DESCRIPTION OF PREFERRED EMBODIMENT(S)

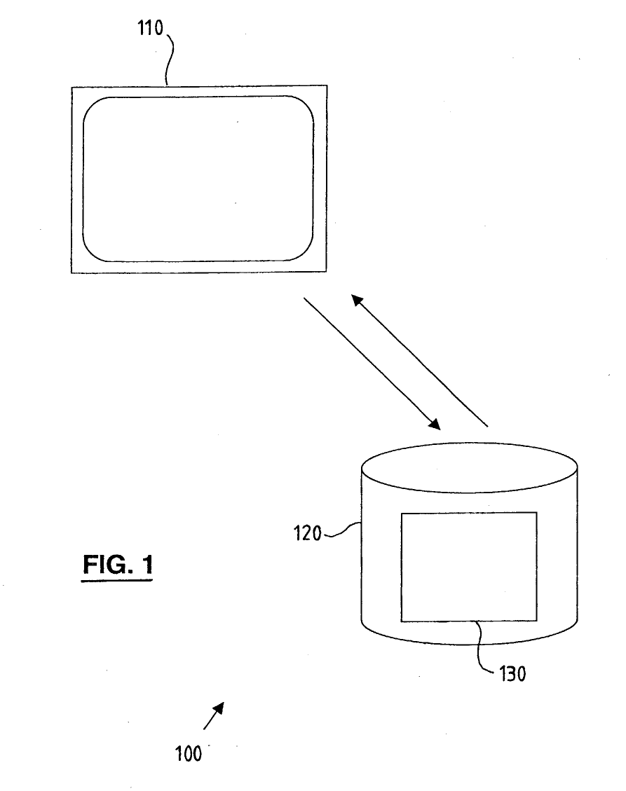

The invention provides a specification of FCM characteristics for the purpose of search, reuse, compare etc., and an FCM Locator 100 (as illustrated in FIG. 1) which demonstrates such usage. The FCM Locator 100 is composed of a client 110 and a server 120. The server 120 is responsible for two tasks: (i) analyzing FCM flows and saving the results (values of their FCM characteristics) in a database table 130, and (ii) when given values for FCM characteristics it can find matching FCM flows in the database. The client enables the user to characterize the desired flows by providing values for their FCM characteristics. It then sends the appropriate search query to the server and presents the result (list of flows).

The FCM characteristics specification specifies flow characteristics for: the purpose of search, reuse, compare etc. In particular, the specification allows the building of a search utility in order to enhance a flow development environment with search and reuse capabilities.

One of the well-known realizations of flows is the Message Flow. It consists of one or more message processing nodes and Message Flow connections between the nodes. Nodes here correspond to the set of components in a flow. A first step towards building a search utility for flows is to build a search utility for Message Flows and generalize it afterwards, e.g., to Work Flows and Connectors. The following section describes flow characteristics and its realization for Message Flows. Note that at this stage we are specifying flow characteristics and not the search engine.

FCM Characteristics For Search and Reuse

Based on the four FCM defined parts, FCM Flow characteristics are here divided into four categories: (i) those that pertain to the logical information structure, (ii) those that pertain to the components that compose the flow, (iii) those that pertain to the flow diagram, and (iv) those that pertain to syntactic properties. In the next section each part is described and the characteristics that pertain to it are specified. For clarity the realization of each characteristic in the Message Flow domain in which a prototype of the FCM Locator is implemented will also provided.

A. The logical Information Structure

The logical information structure defines the structure and format of the information exchanged between components and is defined through the signature of the component's terminals (data mapping may be required between different application component interfaces). Under this part the following characteristics are considered:

Signature settings—a set of signature settings of the flow's composing components. In the domain of Message Flows the signature includes the set of message types associated with the flow's Input and Output terminals.

Data structure fields—those fields of the signature which are manipulated by the components composing the flow. In the context of Message Flows this would be a set of message fields manipulated by the components composing the Message Flow. It is realized via the SQL (Structured Query Language) code inside specific primitive components (DataBase, Compute and Extract).

B. The Components

The components represent the business entities used in the flow model and are defined in terms of their input and output terminals which represent, respectively, the information processed and produced by the component. The terminals are ‘typed’ by reference to the structure of the data passing through them. Components are derived (instantiated) from component types which represent templates for these components. A process component type represents an aggregate of other components, already composed into ‘primitive’ flows. A simple component type represents a business service that is opaque from the perspective of flow composition modeling; it is completely defined by its terminals and associated resources and properties. In addition, auxiliary components enable representation of more complex routing and information mapping rules and resources (any external entity which is used to perform a function or store information for the model) may be bound to the component. Under this part the following characteristics are considered:

Type containment—set of all the components' types which are contained in the flow. This characteristic has a direct realization in the context of Message Flows, e.g., {Compute, Filter, Extract}.

Resource Reference—set of the resources which are used or referenced by the components composing the flow. In the context of Message Flows, two types of resources are identified: one relating to the databases involved in the Message Flow, the other being the queues that correspond to the input/output components. Each entry that relates to a database includes the name of the database, name of a table and a column, type of operation (read/write, etc.) and the name of the component that referenced the database.

C. The Flow Diagram

The flow diagram describes, by means of control and data connections the flow of business events (control triggers) and information between components in flow models, encapsulating simple business rules and information mapping. The flow model thus created may itself be encapsulated into a single process component to be used in a larger flow model. Under this part the following characteristics are considered:

Layout—the graph which represents the flow. This characteristic can be further divided into the following sub-characteristics:

Number of components,

Number of compound components,

Depth of hierarchy, and

Existence of patterns—for example, loop, sequence, compensation and nesting.

Control decisions—representing the control decisions performed by the flow. Note that in FCM this is represented via control connectors; in the domain of Message Flows, control decisions are performed by a Filter component.

Data mappings—representing the data mappings performed by the flow. Note that in FCM this is represented via data connectors. In Message Flows, data mappings are performed by special components, namely the Extract and Compute components.

D. Syntactic Properties

A flow is also characterized by its syntactic properties which include the flow's textual description, its name and its component's names, comments, etc.

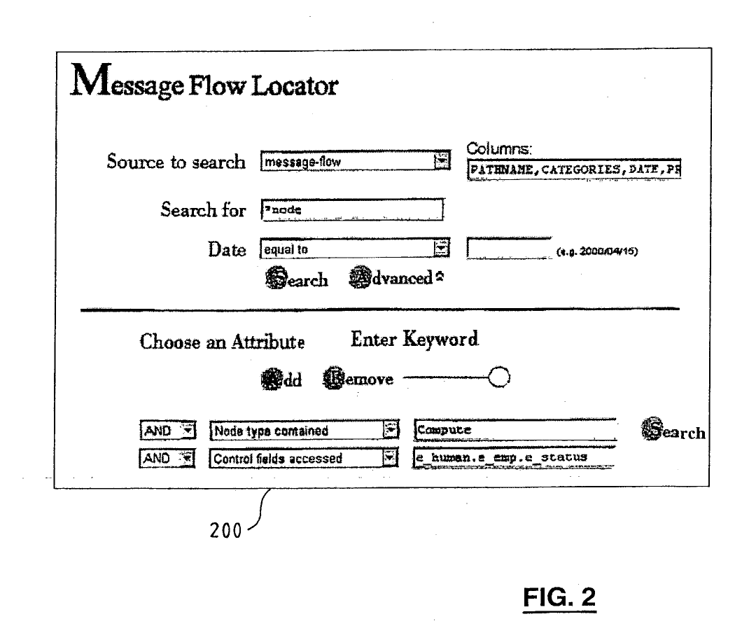

The suggested FCM-based Flow characteristics serve as a basis for development of search and reuse tools for any FCM based realization. The prototype implemented, namely Message Flow Locator, enables the user to characterize the desired Message Flows by providing values for the above characteristics. The illustration of FIG. 2 presents the wizard (running within a common internet browser) that enables the user to perform that task. In this example, in the browser window 200 the user characterizes the desired Message Flows as those that have the word ‘node’ in their syntactic properties, are composed of the ‘Compute’ component type and contain a control decision which is based on the message field ‘e-human.e-emp.e-status’.

A Message Flow Locator prototype has been implemented to enable search and reuse of Message Flows. This implementation demonstrates how the invention can be used for search and reuse of a well known FCM realization Message Flow.

In practice, the Message Flow Locator may be built on top of a generic search and reuse tool which combines the capabilities of an information gathering tool with a search engine to provide reuse, impact analysis, search and discovery.

Another (complementary) technique is to search based on the topology of the flow itself, essentially following a standard string wildcard match analogy.

The search request would consist of a standard looking flow diagram. However, for each kind of connector in a standard diagram there would be four ‘wildcard’ possibilities in the search request diagram:

1. direct connection (equivalent to ‘?’ in a string pattern match),

2. direct/indirect connection (equivalent to ‘*’ in a string pattern match),

3. assertion that NO direct connection exists (equivalent to ‘˜?’), and

4. assertion that NO connection exists, direct or indirect (equivalent to ‘˜*’)

This could be made more sophisticated to allow for number of links in a connection, etc. Similarly, nodes in the search request may be less precise than nodes in a real flow. For example, a search request node may consist of:

1. a fully qualified database node, such as might appear in a real flow,

2. a database node specifying which tables are involved and which database operation (and whether read or write),

3. a database node specifying which tables are involved (and whether read or write),

4. an unspecified database node,

5. an unspecified node.

Thus a sample query may be:

1. find a flow that takes a given style of input [wildcard match on input signature],

2. join it to some database information [wildcard match on database join node], and then

3. publish the result [requires a publish node], and

4. maybe perform other intermediate processing [wildcard style connectors].

Details of the wildcard/search language could be refined by experiment and use. It will be appreciated that as long as there is not too much concern with search efficiency, such a wildcard/search facility may be easily implemented (e.g., using a Prolog-like rules system).

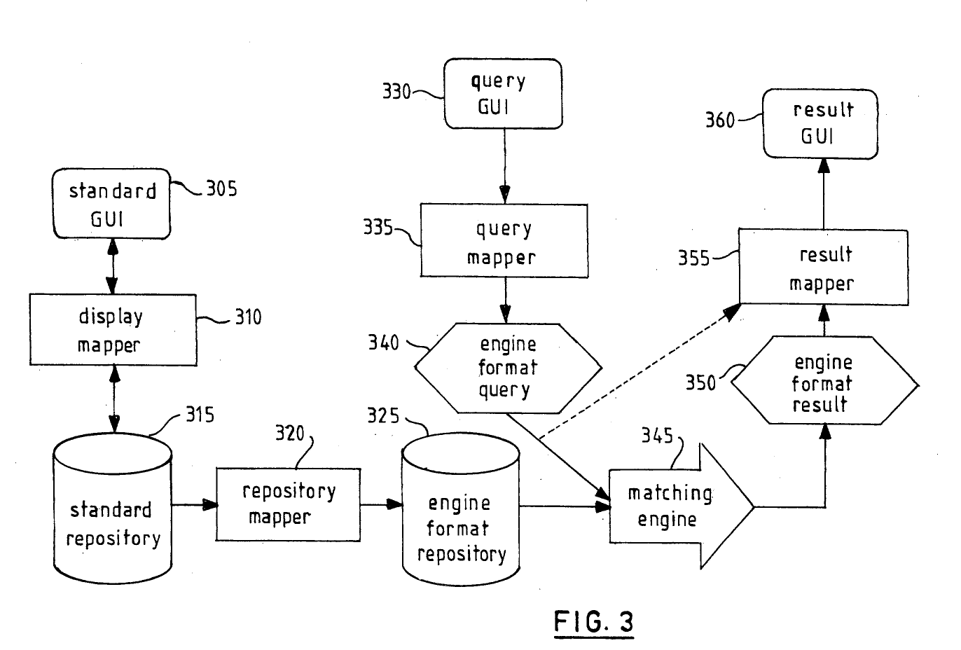

FIG. 3 shows a block schematic diagram illustrating interaction of graphic user interfaces with various repositories et al. to perform FCM viewing, editing and searching utilising the present invention. As shown in the figure:

via a standard GUI 305, a screen shown to a user of one FCM model at a time, as in existing products such as MQSeries Integrator (MQSI).

a display mapper 310 produces code (e.g., HTML—HyperText Markup Language—or XML—Extensible Markup Language—code for viewing in an internet browser) to generate a viewing screen from FCM model, and to edit model from screen changes, as in existing products such as MQSI.

a standard repository 315 holds all models in standard form (typically XML), as in existing products such as MQSI.

a repository mapper 320 converts model information to a format more efficient for matching (e.g., Prolog ‘fact’ format).

an engine format repository 325 holds converted model information.

a query GUI 330 produces a screen used to formulate a ‘pattern’ query (probably on the same physical screen, e.g., in a different browser window such as window 200 of FIG. 2, as the standard GUI 305).

a query mapper 335 maps the query GUI format to a format (e.g., Prolog rules) efficient for a desired query engine.

an engine format query 340 is produced as the result of mapping query to engine format.

a matching engine 345 takes models from engine format repository 325 and matches them against engine format queries 340, to produce

an engine format result 350 the result of a match (or a result set if there are a plurality of matches).

a result mapper 355 prepares engine format result(s) for display (may also use engine format repository 325 to give result display context).

a result GUI 360 produces a display of results in GUI form (probably on same physical screen, e.g., in a different browser window, as the standard GUI 305).

There are several variations where format conversions may be used:

1. The matching engine may work directly on the standard 315 repository, in which case the repository mapper 320 and engine format repository 325 are not needed.

2. The query may be mapped indirectly via a ‘standard’ format (as is the repository in FIG. 3). This replaces the single query mapper 335 with:

query mapper (to standard query format)

standard format query repository

query mapper (to engine format)

3. Similarly, processing on the result path may progress via a ‘standard’ format, with corresponding extra steps.

The particular version shown is preferred because it takes full advantage of existing repositories, but does not add extra steps. Versions with extra mappings have the advantage of easier reuse of the display mapping code (for query and result), but with the extra cost of running the (comparatively simple) code to convert between standard and matching engine formats.

It will be understood that the flow model searching scheme described above provides the advantage that a new specification of flow characteristics, derived from the general model FCM, is used. Hence using it enables the application of search, reuse, compare, etc., on any present and future FCM realization.

It will be appreciated that the methods described above for FCM searching will typically be carried out in software running on a processor (not shown), and that the software may be provided as a computer program element carried on any suitable data carrier (also not shown) such as a magnetic or optical computer disc.

It also be appreciated that although flow modelling has been described above in relation to typical business processing areas, flow modelling is also used in various other areas. For example, many software programs for music editing use flow modelling to represent flow of audio and control data through a ‘virtual’ synthesizer and/or ‘virtual’ sequencer. It will therefore be understood that the present invention is not limited to flow composition modelling of business processing, but may be applied to any flow composition modelling application. For example, in applying the present invention to flow composition modelling in a music program, a search could be made for ‘a flow containing a lowpass filter’, rather than ‘a flow containing a database update node’ as might be encountered in flow composition model searching a business processing application.

It will also be appreciated that various modifications to the embodiment described above will be apparent to a person of ordinary skill in the art.

What is claimed is:

1. An arrangement for flow composition model searching, comprising:
repository means for holding records of flow composition models containing information representative of predetermined flow composition model characteristics thereof;
searching means for specifying information representative of desired at least one of the predetermined flow composition model characteristics; and
retrieval means for retrieving from the repository means flow control model records matching the information representative of desired at least one of the predetermined flow composition model characteristics specified at the searching means.

2. The arrangement of claim 1 wherein the predetermined flow composition model characteristics comprise at least one of:
Message Flow characteristics,
Work Flow characteristics, and
Connector characteristics.

3. The arrangement of claim 2 wherein the Message Flow characteristics comprise at least one of:
logical information structure characteristics,
flow composition component characteristics,
flow diagram characteristics, and
syntactic property characteristics.

4. The arrangement of claim 3 wherein the logical information structure characteristics comprise at least one of:
signature setting characteristics, and
data structure field characteristics.

5. The arrangement of claim 3 wherein the flow composition component characteristics comprise at least one of:
type containment characteristics, and
resource reference characteristics.

6. The arrangement of claim 3 wherein the flow diagram characteristics comprise at least one of:
layout characteristics,
control decision characteristics, and
data mapping characteristics.

7. The arrangement of claim 6 wherein the layout characteristics comprise at least one of:
number of components characteristics,
number of compound components characteristics,
depth of hierarchy characteristics, and
pattern existence characteristics.

8. The arrangement of claim 3 wherein the syntactic property characteristics comprise at least one of:
textual description characteristics,
name characteristics, and
comment characteristics.

9. The arrangement of claim 1 wherein the predetermined flow composition model characteristics comprise flow topology characteristics.

10. The arrangement of claim 1 wherein the information representative of desired at least one of the predetermined flow composition model characteristics comprises ambiguous information, allowing non-precise matches to be made by the retrieval means.

11. The arrangement of claim 10 wherein the ambiguous information comprises a wild card character.

12. The arrangement of claim 11 wherein the wild card character represents one of:
direct connection,
direct/indirect connection,
assertion that no direct connection exists, and
assertion that no connection exists, whether direct or indirect.

13. The arrangement of claim 1 wherein the repository means comprises a data base of which columns are arranged to hold information representative of respective predetermined flow composition characteristics.

14. The arrangement of claim 1 further comprising graphical user interface means for displaying to a user an interactive display for specifying the information representative of desired at least one of the predetermined flow composition model characteristics, and for displaying to the user retrieved matching flow control model records.

15. The arrangement of claim 14 wherein the graphical user interface means comprises browser means for displaying markup language code.

16. The arrangement of claim 1 wherein the flow composition model represents a business process.

17. The arrangement of claim 1 wherein the flow composition model represents a music process.

18. A method for flow composition model searching, comprising:
providing repository means holding records of flow composition models containing information representative of predetermined flow composition model characteristics thereof;
providing searching means specifying information representative of desired at least one of the predetermined flow composition model characteristics; and
providing retrieval means retrieving from the repository means flow control model records matching the information representative of desired at least one of the predetermined flow composition model characteristics specified at the searching means.

19. The method of claim 18 wherein the predetermined flow composition model characteristics comprise at least one of:
Message Flow characteristics,
Work Flow characteristics, and
Connector characteristics.

20. The method of claim 19 wherein the Message Flow characteristics comprise at least one of:
logical information structure characteristics,
flow composition component characteristics,
flow diagram characteristics, and
syntactic property characteristics.

21. The method of claim 20 wherein the logical information structure characteristics comprise at least one of:
signature setting characteristics, and
data structure field characteristics.

22. The method of claim 20 wherein the flow composition component characteristics comprise at least one of:
type containment characteristics, and
resource reference characteristics.

23. The method of claim 20 wherein the flow diagram characteristics comprise at least one of:
layout characteristics,
control decision characteristics, and
data mapping characteristics.

24. The method of claim 23 wherein the layout characteristics comprise at least one of:
number of components characteristics,
number of compound components characteristics,
depth of hierarchy characteristics, and
pattern existence characteristics.

25. The method of claim 20 wherein the syntactic property characteristics comprise at least one of:
textual description characteristics,
name characteristics, and
comment characteristics.

26. The method of claim 18 wherein the predetermined flow composition model characteristics comprise flow topology characteristics.

27. The method of claim 18 wherein the information representative of desired at least one of the predetermined flow composition model characteristics comprises ambiguous information, allowing non-precise matches to be made by the retrieval means.

28. The method of claim 27 wherein the ambiguous information comprise a wild card character.

29. The method of claim 28 wherein the wild card character represents one of:
direct connection,
direct/indirect connection,
assertion that no direct connection exists, and
assertion that no connection exists, whether direct or indirect.

30. The method of claim 18 wherein the repository means comprises a data base of which columns hold information representative of respective predetermined flow composition characteristics.

31. The method of claim 18 further comprising providing graphical user interface means displaying to a user an interactive display for specifying the information representative of desired at least one of the predetermined flow composition model characteristics, and displaying to the user retrieved matching flow control model records.

32. The method of claim 31 wherein the graphical user interface means comprises a browser displaying markup language code.

33. The method of claim 18 wherein the flow composition model represents a business process.

34. The method of claim 18 wherein the flow composition model represents a music process.

35. A computer program element comprising computer program means for performing the method of claim 18.
